(19) United States
(12) Patent Application Publication
(10) Pub. No.: US 2011/0202369 A1
(43) Pub. Date: Aug. 18, 2011

(54) Medical Information Device And Associated Methods

(75) Inventor: Virgil Sanchez, Winter Park, FL (US)

(73) Assignee: SOTERIA DEVICES, LLC, WINTER PARK, FL (US)

(21) Appl. No.: 13/030,423

(22) Filed: Feb. 18, 2011

Related U.S. Application Data
(60) Provisional application No. 61/305,696, filed on Feb. 18, 2010.

(51) Int. Cl. G06Q 50/00; G06Q 10/00

(52) U.S. Cl. 705/3

(57) ABSTRACT

A device and method are provided for improving patient safety preparatory to a surgical procedure. The device is affixable to or adjacent the patient and includes an audio recording and playback medium. The medium can be used to record a message thereon, preferably by the patient. The message is for communicating at least patient identity and planned procedure to, for example, a surgical team. The medium can be activated by a healthcare worker prior to initiating the procedure, such as during a planned “time-out” period. A second recording can also be made by a healthcare worker that contains patient and procedure data to provide yet another safety element. Both recordings are reviewed prior to beginning the surgical procedure to ensure the correctness of the procedure.

### CROSS-REFERENCE TO RELATED APPLICATION

This application claims priority to provisional patent application Ser. No. 61/305,696, filed on Feb. 18, 2010.

### BACKGROUND OF THE INVENTION

1. Technical Field

The present invention relates to patient safety devices and methods, and, more particularly, to devices and methods for ensuring that a patient and related procedure to be performed are correlated correctly.

2. Description of Related Art

Patient safety is at the forefront of healthcare issues on the minds of both healthcare providers and the general public. The November 1999 report of the Institute of Medicine (IOM), entitled “To Err Is Human: Building A Safer Health System,” focused a great deal of attention on the issue of medical errors and patient safety. The report indicated that as many as 44,000 to 98,000 people die in hospitals each year as the result of medical errors. Even using the lower estimate, this would make medical errors the eighth leading cause of death in this country—higher than motor vehicle accidents (43,458), breast cancer (42,297), and AIDS (16,516).

Hospitals are not the only facilities that provide surgical procedures. Over the past 10 years, the number of elective surgical procedures performed in ambulatory and office-based settings have increased significantly. In 2008, 11.7 million cosmetic surgical and nonsurgical procedures were performed in the United States, a 162% increase since 1997. In 2005, the American Society of Anesthesiologists estimated that over 10 million surgical procedures were performed in a doctor's office. This number has doubled since 1995 and continues to grow. Today nearly 80% of all surgeries are performed in an outpatient facility, of which 10% are office-based. It is believed that the standard of care in an office surgical suite should be no less than that of a hospital or ambulatory surgical unit.

In order to ensure safety, in 2004 the Joint Commission on Accreditation of Healthcare Organizations (JCAHO) proposed a tool to help reduce the incidence of medical errors by issuing the “The Joint Commission's Universal Protocol for Preventing Wrong Site, Wrong Procedure, Wrong Person Surgery.” The centerpiece of the protocol is the initiation of a process called a “time-out” or “pause.” The purpose of the “time-out” is “to conduct a final verification of the correct patient, procedure, site, and as applicable, implants.” The process is further described as an active communication among all members of the surgical procedure team, consistently initiated by a designated member of the team, conducted in a “fail-safe” mode; that is, the procedure is not started until any questions or concerns are resolved.

Based upon careful review of 43 cases reported through its Sentinel Event Policy over a three-year period, the JCAHO issued the following recommendations for avoiding wrong-site surgery: (1) Mark the operative site and involve the patient in this process; (2) require oral verification of the correct site in the operating room by each member of the surgical team; (3) follow a verification checklist that includes all documents and medical records referencing the intended operative procedure and site; (4) directly involve the operating surgeon in the informed consent process; and (5) engage in ongoing monitoring to ensure verification procedures are followed.

Among these recommendations, marking the operative site has received the most attention, and yet wrong-site procedures still occur despite time-outs and marking of the operative site. This is reflected in the fact that coordination of healthcare activities involving surgical procedures is highly variable within, as well as among, hospitals and surgical centers. In 2006, the number of surgical procedures performed in the United States was 32.6 million, of which 75% were outpatient procedures.

Additionally, in 2009 the Joint Commission's Comprehensive Accreditation Manual for Hospitals issued a mandate that a time-out must be performed prior to initiating a procedure even if the physician is working alone.

Therefore, it would be beneficial to provide a device and method for increasing the correlation between a patient and an associated planned surgical procedure.

### SUMMARY

The present invention is directed to a device and method for improving patient safety by providing a device having associated therein a verification stream identifying the patient and a planned surgical procedure for the patient, wherein the verification stream can comprise at least one of an audio and a video stream. The device is activatable by a healthcare worker preparatory to performing surgery on the patient in order to optimize a correct correlation of patient and procedure.

The device comprises a base affixable to or adjacent the patient. Associated with the base is a recording and playback medium. The medium can be used to record a message thereon, preferably by the patient, although this is not intended as a limitation. The message is for communicating at least patient identity and planned procedure to, for example, the surgical team. The medium can be activated by a healthcare worker prior to initiating the procedure, such as during a planned “time-out” period.

Among the benefits of the present device and method can be included, but are not intended to be limited to, that it is patient-directed. The patient is empowered in the process by having his/her own voice agree to the basic information of a time-out prior to the procedure, during which time he/she might be under anesthesia or under the influence of psychotropic drugs. Additionally, the invention serves to standardize the time-out process. Recording substantially the same information on every patient is intended to eliminate the variability inherent in time-outs among healthcare workers.

The device and method also reduce errors inherent in known systems. With the device on the patient, the recording eliminates the possibility of an incorrect medical record being used to identify the patient. From the perspective of the healthcare facility, liability is decreased, as a patient-directed time-out serves as a powerful rebuttal to any liability if the procedure as recorded in the patient's script has been followed.

The device as conceived at present is intended to be produced economically, and thus would not significantly impact the cost of a procedure.

### BRIEF DESCRIPTION OF THE DRAWINGS

FIG. 1 is a flowchart of an exemplary method of the present invention.

FIG. 2 is an exemplary schematic drawing of an embodiment of a device of the present invention.

FIG. 3 is a top/side perspective view of an exemplary device of the present invention.

FIG. 4 is a bottom perspective view of the device of FIG. 3.

FIG. 5 is a side perspective view of the device of FIG. 3.

### DETAILED DESCRIPTION OF THE PREFERRED EMBODIMENTS

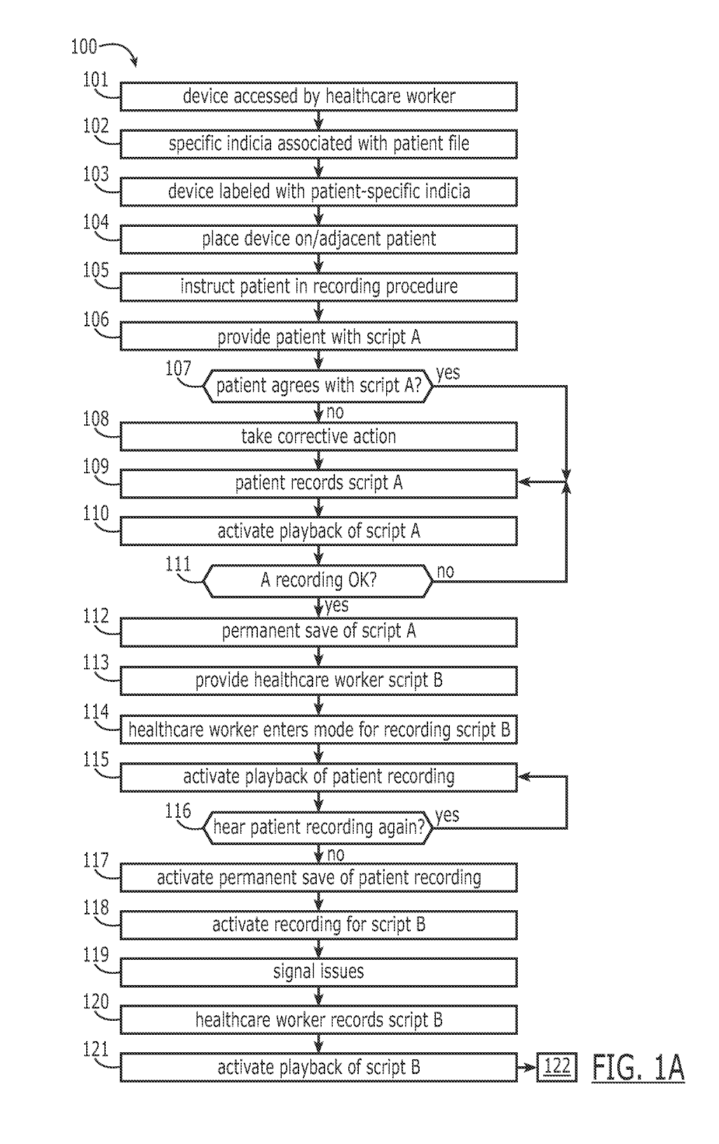

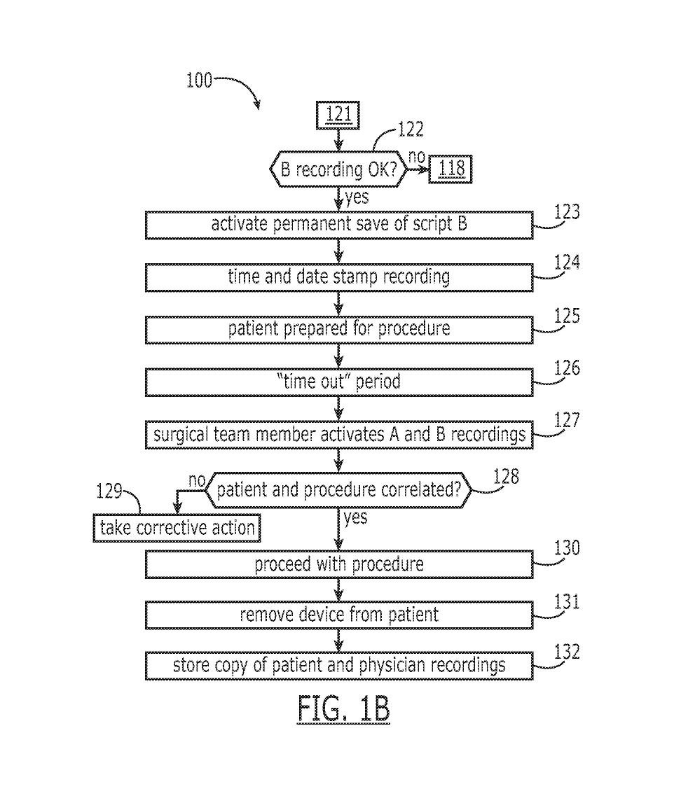

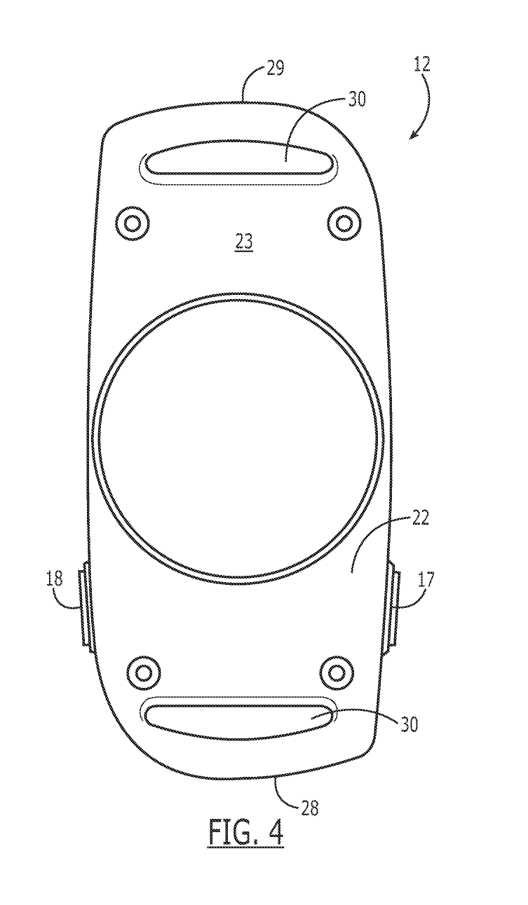

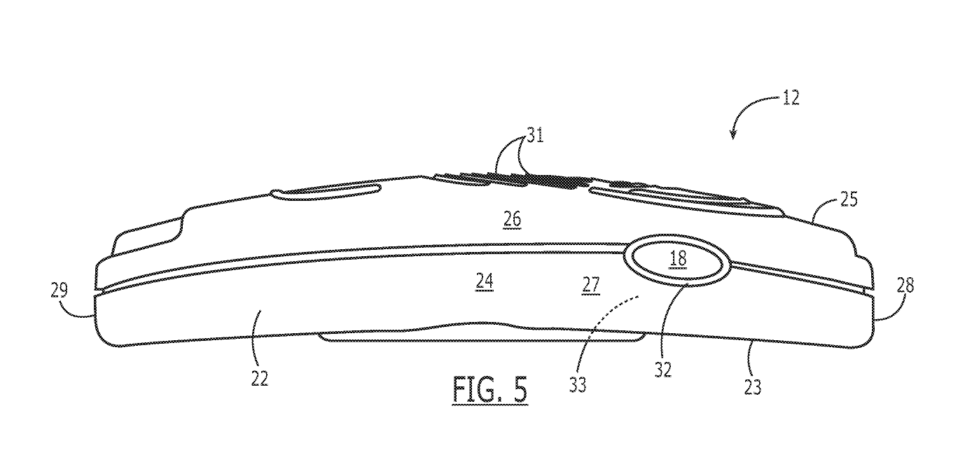

A description of the preferred embodiments of the device 10 and method 100 of the present invention will now be presented with reference to FIGS. 1-5. Throughout the description provided herein, it will be understood by one of skill in the art that the designation “patient” can refer to the patient him/herself, or can refer to a healthcare surrogate, parent, or guardian, depending upon the age and condition of the patient him/herself.

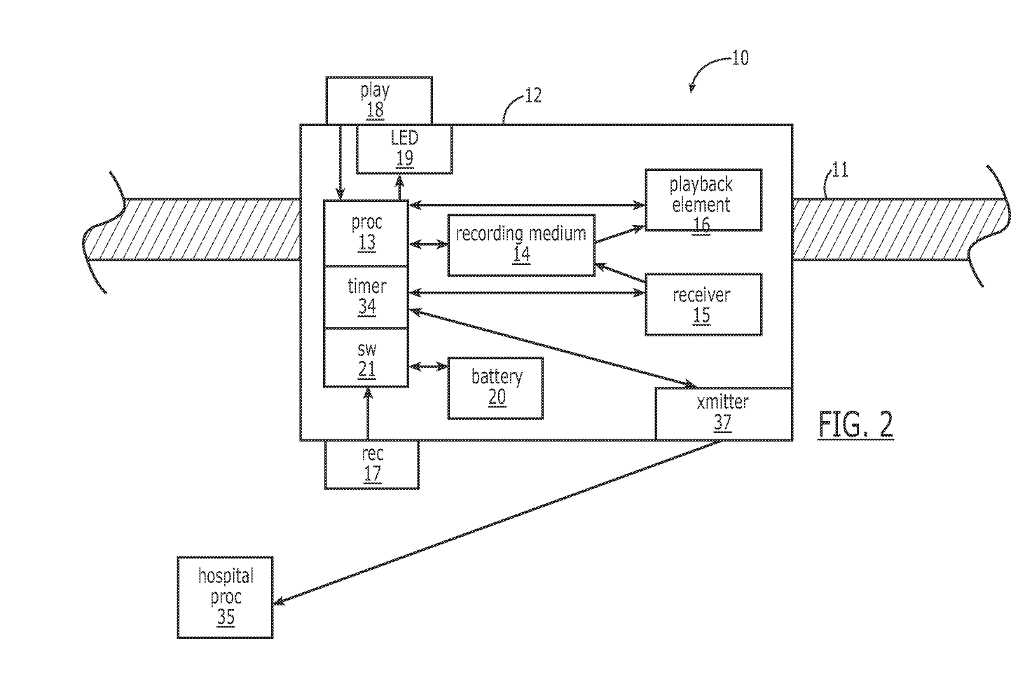

The construction and form of a device 10 can be conceived in a plurality of embodiments, with a device schematic given in FIG. 2. An exemplary device 10 could comprise an affixing element comprising a wristband 11. One of skill in the art will appreciate that a wristband is by no means the only affixing element that could be used, but is useful for purposes of description.

Affixed to the wristband 11 is a recording and playback element 12 comprising a processor 13 and a recording medium 14, a receiver comprising at least one of an audio receiver and a video camera 15, and playback element comprising at least one of an audio speaker and a screen 16 in signal communication with the processor 13. One of skill in the art will recognize that, in the video embodiment, the playback element could comprise an element for transmitting a playback signal to a screen separate from the device 10. An activation (“record”) button 17 is adapted to initiate recording scripts A and B, as received via the receiver 15. A playback (“play”) button 18 is adapted to initiate playing back scripts A and B from the recording medium 14. The record 17 and play 18 buttons can in certain embodiments comprise different indicia for ease of distinguishing them from each other, for example, but not intended to be limited to, different colors such as green for the play button 18 and red for the record button 17. Also provided within the recording and playback element 12 is an indicator, such as an LED 19, the use of which will be described in the following. A battery 20 is in signal communication with the processor 13 and the LED 19 for providing power thereto.

Software 21 is resident on the processor that is adapted for assisting in carrying out the method 100 of the present invention, as will be described in the following. Additionally, the software 21 is adapted to provide an indication when the battery 20 is running low, such as a specified signal via the LED 19 and/or the playback element 16. When the battery 20 reaches a predetermined lower limit, the processor 13 shuts the device 10 down and implements a signal, for example, through the LED 19 and/or the playback element 16.

A timer 34 that is in signal communication with the processor 13 can also be provided in order to place the device 10 into a power saving mode if inactive for a predetermined time. An indication of entering the power saving mode can be provided to the user, such as, but not intended to be limited to, a signal via the LED 19 and/or the playback element 16.

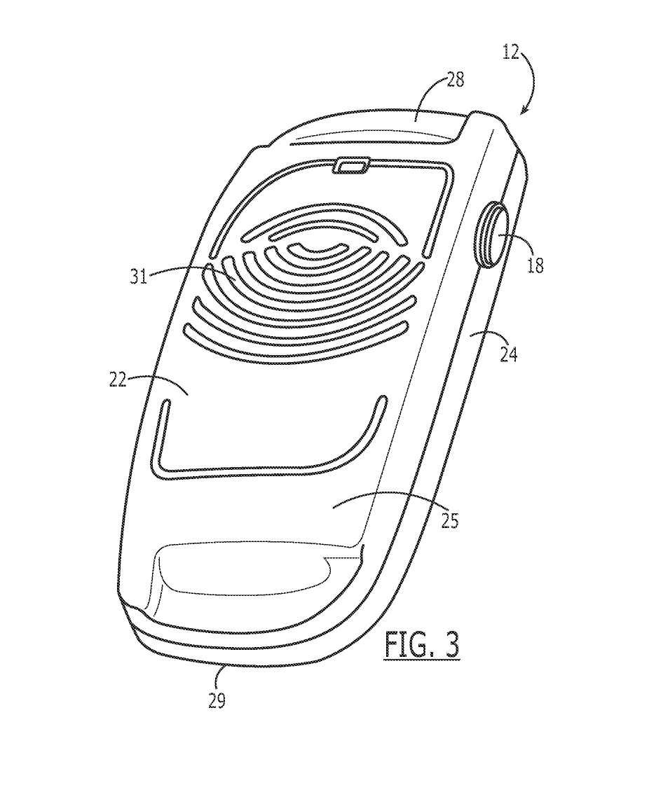

An exemplary case 22 for the device 10 is illustrated in FIGS. 3-5. Preferably the case 22 should be constructed of a durable material and be substantially water-proof. The case 22 should also be lightweight and small to avoid interfering with the patient's procedure. A back face 23 of the case 22 should preferably be smooth so as to avoid irritating the skin of the patient. Sides 24 and top 25 faces should also preferably be smooth to avoid catching on gowns and drapes, and to avoid puncturing surgical gloves. The case 22 can be make by means known in the art, such as, but not intended to be limited to, plastic extrusion methods. The case 22 can comprise a top 26 and a bottom 27 half that are affixable together by means known in the art to form a substantially continuous surface.

The case 22 further has a first 28 and a second 29 end joining the sides 24. The first 28 and second 29 ends comprise in an exemplary embodiment an aperture 30 through which the strap 11 can be threaded.

The top face 25 has an aperture or plurality of apertures 31 for admitting sound therethrough, to which end the play button 18 and receiver 15 are preferably positioned adjacent thereto.

The side faces 24 have opposed apertures 32 extending into an interior 33 of the case 22, through which protrude the play 18 and record 17 buttons, which are constructed as known in the art for pressing inward to activate and return to a “home” position upon release. In an exemplary embodiment, the record button 17 can comprise a translucent material. In some embodiments substantially the entire case 22 can be translucent. The LED 19 can then be positioned therebehind for illuminating the record button 17 when activated.

Further embodiments could include additional features, such as a GPS locator, wireless capability 37 for communication with the healthcare facility's processor, permitting such actions as uploading and downloading information into and from the device 10, and a scannable medium for correlating the patient device 10 with the patient file, for example. For example, a copy of the recorded material could be transmitted to a processor 35 at the healthcare facility in order to have redundancy in the records and in case review is desired at a later date. In addition, it will be understood by one of skill in the art that such communication between devices can encompass handheld communication devices such as “smart” phones and tablets as well as server-mediated communication.

A flowchart of an exemplary method 100 of the present invention is depicted in FIG. 1. In a particular embodiment an information and safety device 10 is obtained or accessed by a healthcare worker (block 101). For example, the device 10 could be contained in packaging that is preferably hypoallergenic and water-proof. The device 10 can also have (preferably unique) indicia associated therewith, such as a serial number, bar code, etc.

The device can be provided to the patient upon admission, or later as deemed desirable. The device indicia are then associated with the patient's medical file (block 102). As an example, not intended to be limiting, the device and/or packaging could have associated therewith a tag with adhesive that is removable from the device 10 and/or packaging that can be transferred to the patient's file.

Preferably the device 10 is also labeled with patient-specific indicia (block 103), which can be accomplished in similar fashion to the bracelets commonly used in hospitals at present, although this is not intended as a limitation. The device 10 is then placed on or adjacent the patient (block 104). In the embodiment discussed above, the device 10 is attached to the patient's wrist using the strap 11 provided.

The patient is then instructed in a procedure for using the device 10 (block 105), which can include a procedure similar to that used for recording messages on greeting cards, although this is not intended as a limitation. The device 10 has associated therewith an “on” procedure and a first activation element (e.g., a button) for patient use.

The patient is provided with a first script, referred to as “script A” (block 106). Script A can include, for example, patient name, date, surgical procedure to be performed (e.g., ACL repair), the location of the procedure (e.g., left knee), the healthcare worker(s) performing the procedure, and any other relevant information (e.g., patient allergies, DNR instructions). The patient reviews script A and indicates agreement or disagreement therewith (block 107). If the patient does not agree with script A, corrective action may need to be taken by the healthcare facility regarding the information contained therein (block 108). Alternatively, the patient could be incorrect in his/her disagreement, and an explanation may need to be provided to the patient.

Once script A is settled in form, the patient activates the device and records script A (block 109) by long-pressing the record button 17, upon which an indication can be provided that the device 10 is ready to record. Such an indication can include, but is not intended to be limited to, the sounding of a tone through the playback element 16 and/or a flashing of the LED 19.

The patient continues to depress the record button 17. Upon completion, the patient releases the record button 17, which initiates a playback of script A (block 110) to ensure that it is correct (block 111). The script can be re-recorded as desired until the patient is satisfied, at which point a permanent “save” is activated on the device, for example, by taking no action for a pre-determined time period (block 112), after which the recording of script A cannot be changed. Should a change be desired at this point, a new device will typically need to be provided and activated, although other methods of over-riding a permanent “save” may be envisioned by one of skill in the art.

Another element of the method 100 can include a healthcare worker's being able to record a second script, referred to as “script B.” Script B is provided to and is approved by a healthcare worker (block 113). Script B can include such elements as, but not intended to be limited to, name(s) of healthcare worker(s) performing the procedure, an identification of type and location of procedure, patient name, patient allergies, date of procedure, and other relevant information (e.g., acknowledgment of DNR order). The healthcare worker enters a mode for recording script B (block 114), for example, by a predetermined sequence of actions. In a particular embodiment, the healthcare worker first depresses both the record 17 and the play 18 buttons substantially simultaneously, and then alternately pushes the record 17 and play 18 buttons. A message issues from the playback element 16, such as “You have entered the Physician mode.”

The device 10 then plays back the patient recording (block 115). If the healthcare worker wishes to hear the patient recording again (block 116), the healthcare worker depresses the play button 18 again (block 115); otherwise, the patient recording is committed (block 117).

The healthcare worker is then permitted to record script B into the device 10 by pressing and holding the record button (block 118), and, following the issuance of a signal (block 119), records script B (block 120), along with the physician's name, the date, an acknowledgment that the patient's recording has been reviewed, and a description of the procedure to be undertaken.

When the record button 17 is released, the healthcare worker's recording plays automatically (block 121). If not satisfied with the recording (block 122), the message can be re-recorded (block 118) by long-pressing the record button as above. As above, a permanent “save” of script B is activated (block 123) if nothing further is done. In some instances it may be desired for the software 21 to direct a time and date stamping of the recording (block 124).

Typically a next step is to prepare the patient for the designated procedure (block 125). During a “time-out” period (block 126) before beginning the procedure, a surgical team member activates the A and B recordings (block 127). If the patient and procedure do not correlate (block 128), appropriate corrective action is taken (block 129). If the correlation is correct (block 128), the team can proceed with the procedure (block 130), subject to other facility and medical protocols.

Once the procedure is complete, device 10 is removed from the patient (block 131). It may be desired to store an audio and/or written copy of the recordings to associate with the patient's file for subsequent review as needed/desired (block 132), which can be accomplished by transmitting the recordings to the hospital processor 35 either wirelessly or directly from the device 10. This is not intended as a limitation, as one of skill in the art will appreciate that communication and data transfer can occur between devices in ways known in the art as well as in ways and using devices that will be developed in the future. An electronic verbal version of the recordings could be made using a speech recognition protocol or transcription.

What is claimed is:

1. A method for improving patient safety preparatory to a performance of a procedure by a surgical team comprising, prior to initiating the procedure:
associating a recording and a playback device with a patient;
receiving a patient recording on the device including at least patient name and identification of a procedure to be performed on the patient;
receiving a physician recording on the device including at least the patient name and identification of the procedure to be performed on the patient;
playing the patient and the physician recordings on the device to at least one member of a surgical team;
performing a correlation between the patient and the physician recordings; and
if the physician and the patient recordings do not correlate, halting the procedure.

2. The method recited in claim 1, wherein the device-associating step comprises associating substantially common indicia with the device and a patient chart.

3. The method recited in claim 1, wherein:
the patient-recording-receiving step comprises receiving a first indicator to initiate a recording and receiving the patient recording; and
the physician-recording-receiving step comprises receiving a second indicator to initiate a recording and receiving the physician recording, wherein the second indicator is different from the first indicator.

4. The method recited in claim 3, further comprising, following the second-indicator-receiving step and prior to the physician-recording-receiving step, issuing an alert that the physician statement will be recorded.

5. The method recited in claim 1, further comprising, following the patient-recording-receiving step, playing the patient recording back to the patient and, if the patient recording is unacceptable to the patient, receiving a revised patient recording, replacing the patient recording with the revised patient recording.

6. The method recited in claim 5, further comprising, following the physician-recording-receiving step, playing the physician recording back to the physician and, if the physician recording is unacceptable to the physician, receiving a revised physician recording, replacing the physician recording with the revised physician recording.

7. The method recited in claim 1, further comprising, prior to the patient-recording-receiving step, providing the patient recording to the patient and receiving patient approval of the patient recording.

8. The method recited in claim 1, further comprising, prior to the patient-recording-receiving step, playing the patient recording to the physician for approval.

9. The method recited in claim 1, further comprising, following the patient- and the physician-recording-receiving steps, transmitting the patient and the physician recordings to a storage device.

10. The method recited claim 1, further comprising, following the correlation-performing step, if the physician and the patient recordings correlate, receiving an indication of the correlation.

11. A device for improving patient safety preparatory to a performance of a procedure by a surgical team comprising:
a base;
a processor affixed to the base;
a first input element in signal communication with the processor comprising a record indicator affixed to the base;
a second input element in signal communication with the processor comprising a play indicator affixed to the base;
a third input element comprising at least one of a microphone and a video camera in signal communication with the processor affixed to the base;
a transmitter, a recorder, and a playback device, each in signal communication with the processor affixed to the base; and
software resident on the processor comprising code segments adapted for:
receiving a first signal from the record indicator;
receiving via the third input element a patient recording including at least patient name and identification of a procedure to be performed on the patient;
storing the patient recording on the recorder;
receiving a second signal from the record indicator;
receiving via the third input element a physician recording including at least the patient name and identification of the procedure to be performed on the patient;
storing the physician recording on the recorder
receiving a signal from the play indicator;
playing through the playback device the patient and the physician recordings; and
transmitting the patient and the physician recordings to a remote storage device via the transmitter.

12. The device recited in claim 11, wherein the device further comprises means for associating the device with a patient chart.

13. The device recited in claim 11, wherein the second signal is different from the first signal.

14. The device recited in claim 13, wherein the software further comprises a code segment adapted for, following the second-signal-receiving code segment and prior to the physician-recording-receiving code segment, issuing an alert via the playback device that the physician recording will be recorded.

15. The device recited in claim 11, wherein the software further comprises code segments adapted for, following the patient-recording-receiving code segment, playing the patient recording back to the patient via the playback device, receiving a signal that the patient recording is unacceptable to the patient, receiving a revised patient recording, and replacing the patient recording with the revised patient recording on the recorder.

16. The device recited in claim 15, wherein the software further comprises code segments adapted for, following the physician-recording-receiving code segment, playing the physician recording back to the physician and, if the physician recording is unacceptable to the physician, receiving a revised physician recording, replacing the physician recording with the revised physician recording.

17. The device recited in claim 11, wherein the software further comprises a code segment adapted for, prior to the patient-recording-receiving code segment, playing the patient recording through the playback device to the physician for approval.

18. The device recited in claim 11, wherein the software further comprises a code segment adapted for, following the patient- and the physician-recording-receiving code segments, transmitting the patient and the physician recordings to a storage device via the transmitter.

19. The device recited claim 11, wherein the software further comprises a code segment adapted for, following the correlation-performing code segment, if the physician and the patient recordings correlate, receiving an indication of the correlation.
